(19) United States
(12) Patent Application Publication
(10) Pub. No.: US 2009/0014218 A1
(43) Pub. Date: Jan. 15, 2009

(54) METHOD FOR DATA TRANSMISSION IN A SERIAL COMMUNICATION PROTOCOL BY MEANS OF TELEGRAMS AND DATA TRANSMISSION DEVICE USING THIS METHOD

(76) Inventors: Andreas FUCHS, Berlin (DE); Christoph Meske, Teltow (DE)

Correspondence Address: MCGLEW & TUTTLE, PC, P.O. BOX 9227, SCARBOROUGH STATION, SCARBOROUGH, NY, 10510-9227, US

(21) Appl. No.: 12/171,512

(22) Filed: Jul. 11, 2008

(30) Foreign Application Priority Data
Jul. 13, 2007 (DE) 10 2007 032 659.0

(51) Int. Cl. H04L 15/00

(52) U.S. Cl. 178/2 B

(57) ABSTRACT

A method for data transmission in telegrams in a serial communication protocol comprises the following steps:
assigning the user data to be transmitted to telegrams the basic structure of which comprises
   a telegram header which includes information data about the telegram length, addressing, distribution of the user data to be transmitted into several telegrams or the like;
   a user data block which includes at least a part of the user data to be transmitted; and
   a checksum block which includes a checksum that is determined according to a checksum algorithm at least from the user data; and
transmission of the telegrams in consecutive intervals along a data transmission path.
In this process, the user data block of the telegrams is divided into several user data sub-blocks each of which is protected individually by checksum sub-blocks.

### BACKGROUND OF THE INVENTION

1. Field of the Invention

The invention concerns a method for data transmission in a serial communication protocol by means of telegrams and a data transmission device using this method, in particular a contactless data transmission device in measuring systems.

2. Background Art

With reference to the background of the invention, it is necessary to explain some of the basic principles of data communication in particular when using serial communication protocols.

During a data transmission, it is common practice in communications engineering to split up larger amounts of data which are then transmitted in separate so-called telegrams. As can be seen from FIG. 4, these telegrams are generally structured as follows: telegrams start with a telegram header which is usually and hereinafter referred to as header 1 and contains information concerning the telegram length and the addressing thereof, for example. Moreover, the header 1 must generally contain information concerning the distribution of the larger amount of data into separate telegrams. In many cases, the header 1 starts with an initial sequence, a preamble, that always remains the same. The header 1 is then followed by the actual user data that are arranged in a user data block 2. A checksum in the checksum block 3 for detecting potential transmission errors during the transmission of the telegram marks the end of the telegrams. This checksum procedure for data protection in a serial communication protocol utilizes constant initial values for the checksum calculation. Usual values are zero or one. Of course, sender and receiver need to use the same initial values. The so-called Ethernet standard uses a checksum algorithm known as CRC32 which is described in the trade publication “IEEE Standard for information technology—Part 3: Carrier sense multiple access with collision detection (CSMA/CD) access method and physical layer specifications”, IEEE Std 802.3™-2005 (hereinafter referred to as “IEEE 802.3). The checksum is calculated on the basis of the variable part of the header 1 and the user data in block 2.

The transmission reliability that is achievable by means of this general structure now depends on the length of the data telegram. A well-known study regarding this issue was published in the trade publication “32-bit Cyclic Redundancy Codes for Internet Applications”, preprint of a regular paper to appear in “The International Conference on Dependable Systems and Networks (DSN)” 2002 by P. Koopman (hereinafter referred to as “Koopman”). This paper focuses on the relation between the length of a message and a quantity representing the reliability of transmission, the so-called Hamming distance. The message length is the number of protected bits (not including the CRC). Koopman shows the relation between message length in bits and maximum Hamming distance for the polynominal CRC-32 according to IEEE 802.3. The following is a shortened version of the table 1 from Koopman:

TABLE 1
Hamming distance of CRC-32 according to IEEE 802.3 depending
on the length of the message

| | Message length in |
|---|---|
| Hamming distance | bits |
| 15 | 8-10 |
| 14 | — |
| 13 | — |
| 12 | 11-12 |
| 11 | 13-21 |
| 10 | 22-34 |
| 9 | 35-57 |
| 8 | 58-91 |
| 7 | 92-171 |
| 6 | 172-268 |
| 5 | 269-2974 |
| 4 | 2975-91607 |
| 3 | 91608-131072 |
| 2 | . . . |

Higher safety requirements require a higher Hamming distance. As can be seen from table 1, the transmittable message length is reduced when the Hamming distance increases. If for example a Hamming distance of 10 is required, the available number of bits amounts to a maximum of only 34, which must be sufficient to not only transmit addressing information and information about the telegram length but also the user data.

In order to establish a relation between a desired safety requirement and the Hamming distance, it is necessary to determine the residual error probability R and the transmission error rate A.

According to GS-ET-26: “Principle Rules for test and certification of bus systems for the transmission of safety relevant messages”; HVBG, Gustav-Heinemann-Ufer 130, 50968 Cologne/Germany; edition of May 2002 (hereinafter referred to as “GS-ET-26) chapter 3.6.1.2, and the standard draft “Industrial communication networks—Profiles—Part 3: Functional safety fieldbuses (IEC 65C/351/CD:2004)”, July 2005, (hereinafter referred to as “DIN IEC 61784-3”), chapter 5.7.2, the following applies to the residual error probability R:

$$R ( p ) = {\sum }_{e = d}^{n} {A}_{n , e} {{p}^{e} ( 1 - p )}^{( n - e )}$$

$$wherein$$

$${A}_{n , e} = ( \begin{matrix}n \\ e\end{matrix} ) = \frac{n !}{e ! ( n - e ) !}$$

n message length in bit
p bit error probability
d Hamming distance of the implemented data protection mechanism

The errors per unit time (transmission error rate Λ) resulting from R(p) may be determined by means of the following formula:

Λ=3600·R(p)·v·(m−1)·100

wherein
v number of safety-relevant message/s
R(p) see above
(m−1) worst case number of transmissions in the case of m users. Since a bus system may be configured individually, it must therefore be assumed that there is a maximum number of users.
100 factor 100 signifies that the contribution of the transmission to the safety function amounts to only 1%
Λ transmission error rate, i.e. transmission error/hour.

The relation between the SIL level that is defined for determining the functional safety of technical appliances and the transmission error rate A according to GS-ET-26 and DIN IEC 61784-3 can be taken from the following table:

TABLE 2
Relation between transmission errors per hour and SIL level

| SIL | Λ |
|---|---|
| 3 | <10⁻⁷ |
| 2 | <10⁻⁶ |
| 1 | <10⁻⁵ |

The disadvantage of the checksum protection system according to prior art is that in the event of increased requirements in terms of transmission reliability, the user data length approaches zero, with the result that the number of data telegrams required for transmitting a particular amount of data increases.

In theory, this problem could be solved by using even more sophisticated procedures based on CRC checksums, for instance using 64 bits. The verification of the maximum Hamming distance is extremely difficult, though; it is unknown whether any trials have been performed. Such a verification is however required for safety applications. Therefore, there is no other way but to resort to the conventional checksum procedures using a verified Hamming distance.

### SUMMARY OF THE INVENTION

In relation thereto, it is the object of the invention to provide a method for data transmission in a serial communication protocol by means of telegrams which enables a desired user data length to be achieved in a telegram by means of CRC checksum procedures using a verified, in particular high Hamming distance.

This object is achieved by a method for data transmission in telegrams in a serial communication protocol in which the user data block of a telegram is divided into several user data sub-blocks of which each is individually protected by means of checksum sub-blocks with a Hamming distance that has been verified accordingly.

According to the invention, each of the telegrams is thus protected by more than one CRC checksum. From a logical point of view, each telegram then disintegrates into several segments which are protected by an individual CRC checksum each.

The particular advantage of the invention is that relatively simple CRC checksum algorithms with known Hamming distance may be used for transmitting user data amounts of any desired size even in the case of demanding safety requirements. In contrast to conventional protection procedures, the transmission channel is subject to less load when the header information is transmitted. A particularly large advantage is achieved when the message length n protected by the checksum is small. This is in particular the case in the event of high requirements in terms of the Hamming distance, as shown above in table 1.

In an embodiment of the method, the information about the telegram length is contained in the protected part of the header, allowing the checksum determination to take place. According to a method wherein each user data sub-block is followed by a checksum sub-block which protects the former, the individual checksum sub-blocks may be arranged for example at constant distances between the user data sub-blocks. The length of the last user data sub-block may therefore be smaller than the defined length of the other user data sub-blocks.

It is however also possible for the checksum sub-blocks of the individual user data sub-blocks to be arranged separately at a defined position in the data telegram, with all sub-blocks preferably being positioned upstream or downstream of the successive user data sub-blocks, for example, thus enabling different positions to be selected for the checksum sub-blocks in the data telegram.

According to another alternative which is not disclosed separately in a dependent claim, the transmission of the telegram length in the header may be dispensed with by working with a constant telegram length instead. This may be useful in specific applications with constant data telegram lengths.

An advantageous development of the invention may be performed by adding a segment count or a count value, respectively, which is assigned to each user data sub-block and represents the position of the respective user data sub-block in the telegram, wherein the segment count is also protected by the respective checksum sub-block, thus preventing complete telegram segments from getting lost or arriving at the receiver in the wrong order without being detected as such. By adding the segment count, plausible interpretations of the telegram contents by the receiver are impossible when segments are lost or arrive in the wrong order. This satisfies the requirements for a data transmission as it is stipulated by GS-ET-26, section 2.9.2 “Loss” and section 2.9.4 “Sequence”.

In another advantageous development of the invention in which an initial value is set for determining the checksum of a respective checksum sub-block in dependence of the telegram position of the user data sub-block protected thereby, the initial checksum value is systematically modified for each segment of the telegram. This way, the function of a segment count is implemented implicitly without requiring the transmission of a byte. A verification of the segments on the side of the receiver is possible if the receiver knows the modification pattern of the initial value. The segments are thus indirectly marked in the checksum and receive a unique position in the telegram.

Finally, the invention also concerns a data transmission device and in particular a contactless data transmission device in measuring systems, the data transmission device conventionally comprising a data preparation device on the side of the sender which arranges the data to be transmitted in telegrams, a data sender unit, a data transmission path disposed down-stream thereof for transmitting the data telegrams emitted by the data sender unit, a data receiver unit disposed downstream thereof for receiving the data telegrams and a data evaluation device for further processing of the data telegrams. According to the invention, the data preparation and data evaluation devices are designed such that a data transmission in telegrams takes place according to the inventive method.

According to a preferred embodiment of a data transmission device, the data transmission device comprising a data sender unit, data transmission path and data receiver unit may be designed as an inductive contactless plug connection. Said plug connection may preferably be used for data transmission in measuring systems between a measuring sensor and a measuring device, in particular between a pH measuring sensor and a field device.

Further features, details and advantages are set forth in the following description which is a more detailed explanation—by means of the enclosed drawings—of embodiments of the data transmission process and a pH measuring device using this process.

### BRIEF DESCRIPTION OF THE DRAWINGS

FIG. 1 shows a schematic view of a data telegram comprising individually protected segments;

FIG. 2 shows a schematic view of a telegram comprising individually protected segments and segment counts;

FIG. 3 shows a schematic view of a data telegram comprising individually protected segments and a variable initial checksum value;

FIG. 4 shows a basic view of a protected Ethernet data telegram (prior art); and

FIG. 5 shows a schematic diagram of a pH measuring system comprising a protected data transmission device.

### DESCRIPTION OF THE PREFERRED EMBODIMENTS

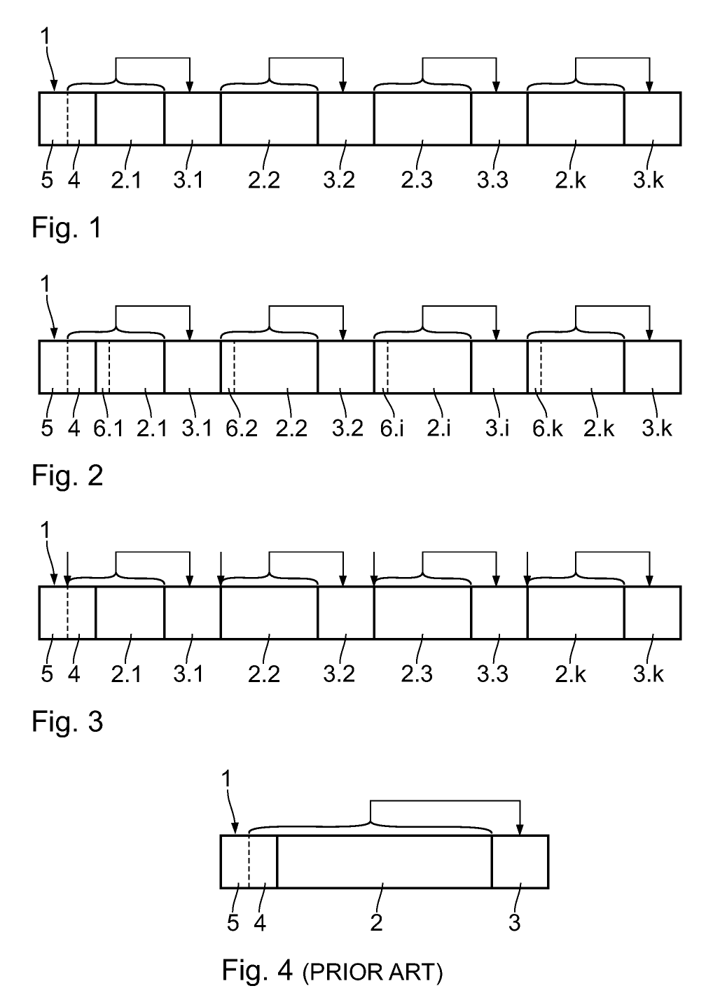

A data telegram which is used for data transmission in telegrams comprising individually protected segments shall be described by means of FIG. 1. The data telegram comprises a telegram header, hereinafter referred to as header 1, which usually comprises a non-variable initial sequence 5 that remains the same for all telegrams and a variable header part 4 which contains information about the telegram length and the addressing thereof, for example. The header 1 is followed by user data sub-blocks 2.1 to 2.k which are each protected by checksum sub-blocks 3.1 to 3.k, respectively. In each of the checksum sub-blocks 3.1 to 3.k, checksums are stored which are determined according to the checksum algorithm CRC32 and have a verified Hamming distance. The checksum in the first checksum sub-block 3.1 also comprises the data contained in the variable header part 4. The user data sub-blocks 2.1 to 2.k−1 have constant lengths, wherein the last user data sub-block 2.k may be smaller, thus equaling the remaining amount of data.

A telegram comprising individually protected segments as well as segment counts shall be described by means of FIG. 2. Again, this telegram starts with a header 1 comprising an initial sequence 5 and a variable header part 4. In contrast to the telegram according to FIG. 1, each user data block 2.1 to 2.k now starts with a count value 6.1 to 6.k of the values 1 to k. Again, the respective checksum sub-blocks 3.1 to 3.k following each user data sub-block 2.1 to 2.k thus formed contain a checksum which is determined according to the checksum algorithm CRC32 and therefore also protects the respective count values 6.1 to 6.k. Thus, a telegram comprising individually protected segments as well as a high Hamming distance is formed which may have a desired user data length and is protected against loss or inversion of entire segments. Moreover, it must be noted that the count values 6.1 to 6.k representing the respective segments need not necessarily be positioned at the beginning of each user data sub-block 2.1 to 2.k. In fact, they may be arranged at any desired position in the user data sub-blocks 2.1 to 2.k.

In the telegram comprising individually protected segments and a variable initial checksum value according to FIG. 3, a restriction of the user data length by the respective count value 6.1 to 6.k is avoided by implementing a virtual segment count in the simplest embodiment of such a telegram having a variable initial checksum value. The number i serves as initial value of the checksum algorithm for each k-th checksum sub-block 3.i, with i running through the ordinal numbers from 1 to k. Since the receiver of the telegram follows the same routine for verifying the checksum, the virtual segment count also provides for protection against loss or inversion of segments. In contrast to the telegram comprising individually protected segments and a segment count according to FIG. 2, however, this process requires at least one byte less per user data sub-block 2.1 to 2.k.

The functional design of a data transmission device 8 that is able to use the above described data transmission methods shall be explained in connection with FIG. 5 by means of the example of a plug connection system comprising the plug element 17 and the socket element 18 for connection of a sensor device 7. The sensor device 7 comprises for example an elementary sensor 12 for measuring a pH and/or a redox potential of a process liquid 11 and an elementary sensor 13 for measuring the temperature of the process liquid. Each sensor 12, 13 delivers an analogue voltage signal that is transmitted to the A/D converter 22 signal-coupled therewith, the A/D converter 22 acting as data preparation device in the plug element 17. The A/D converter 22 is integrated into a microcontroller 15 which, as central control and storage unit, is functionally responsible for the basic control functions, the processing of command and measuring data as well as the transmission thereof as it is known from prior art, thus acting as a data preparation device within the scope of the invention.

Moreover, a circuit arrangement is provided as data transmission path between the plug element 17 and the socket element 18, the circuit arrangement comprising an energy-signal receiver 23 and a data modulator/demodulator unit 24 as well as a first coupling partner element 16 acting at least as a data sender unit for the inductive contactless coupling path 19.

The second coupling partner element 20 at least acts as a data receiver unit and is disposed near the head of the socket element 18. The coupling partner element 20 is connected to a circuit arrangement comprising an energy-signal transmitter 25 and a modulator/demodulator unit 26. In analogy to the plug element 17, a microcontroller 21 is also disposed in the socket element 18, the microcontroller 21 being responsible for the central control and storage functions in terms of energy supply and data exchange of the plug connection system, thus acting as a data evaluation device within the scope of the invention. The exchange of data takes place via an RS 485 modem acting as data interface 28 to a profibus field device 9 which is connected to the socket element 18 via a cable 10. Finally, the entire plug connection unit is supplied with energy via a primary current supply 29. The entire plug connection system comprising the sensor device 7 complies with the regulations concerning explosion protection.

Finally, an optical diagnostic display unit, the entirety of which is designated by 31, is provided in the socket element 18, wherein the optical diagnostic display unit 31 is actuated by the microcontroller 21 and comprises three light-emitting diodes 32, 33 in the displayed example. The function of these diodes is to display status parameters of the measuring and transmission system.

The following is a short outline of the basic mode of operation of the plug connection system as it is known per se from prior art. Starting on the side of the sensor, the two analogue signals delivered by the two elementary sensors 12, 13 are digitized in the A/D converter 22. The microcontroller 15 calculates the respective measuring values and transmits these values to the circuit component comprising the energy signal receiver 23 and the modulator/demodulator unit 24. The circuit component converts the digital information about the measuring values into a modulation which is suitable for transmission via the inductive coupling path 19, wherein suitable possibilities include an amplitude, frequency or phase modulation. This process uses the data telegrams described above within the scope of the inventive method. On the side of the socket element 18, the respective digital information is filtered out by the modulator/demodulator unit 26 and is then processed by the microcontroller 21 acting as data evaluation device before being transmitted—via the data interface 28 and the bus line in the cable 10—to the field device 9 for further processing. The microcontroller 21 controls the data flow by switching the data interface 28 from Receive to Send.

Starting from the primary current supply 29 on the base side, the energy signal transmitter 25 and the modulator/demodulator unit 26 are controlled by the microcontroller 21 such that in order for the entire plug connection system to be supplied with current, energy supply signals such as a carrier voltage are transmitted via the coupling path 19 along with modulated data signals serving, for example, for parameterization of the sensor unit 7. This carrier voltage is processed by the energy signal receiver 23 and the modulator/demodulator unit 24 such that it suffices for the entire voltage supply of the components in the plug element 17.

The displayed inductive plug system thus provides a contactless plug connection between sensor 7 and cable 10. The plug system enables a reliable pH measurement to be achieved without being interfered by ambient conditions since numerous interference susceptibilities of contact-carrying plug systems to humidity, contamination or corrosion are eliminated. The system reliably prevents coupling of the potentials of medium and measuring transducer.

Moreover, the inductive plug system has further advantages. One characteristic of the system is that the measuring signals are already digitized in the sensor, thus enabling the signal to be transmitted digitally. Therefore, apart from the normal measuring signal, other information may be included as well, such as information concerning the sensor type, the serial number or the calibration data, thus automatically ensuring that the parameterization of the device and the calibration data are always matched to the sensor 7. This substantially increases operational safety, which is essential for measuring points with SIL requirements. Information about loads on the sensor 7 caused by extreme ambient conditions such as high temperatures may also be included and evaluated upon being transmitted to the measuring device in terms of preventive maintenance.

Generally, the contactless plug connection may be used for all types of sensors. The pH sensor 7 shall therefore be regarded as an exemplary embodiment.

The signals are transmitted digitally in the inductive plug system. A unique protocol is used for data transmission. The sensor data to be transmitted are transmitted serially from the sensor 7 to the field device 9. Due to the requirement to store the most different types of information in the plug element 17 of the sensor 7, relatively large amounts of data are obtained. As mentioned above, these may include manufacturer information about the sensor 7, such as serial numbers, type designations or a manufacturer code. The information stored in the sensor 7 may however also be composed of calibration data. Furthermore, it is also conceivable to store information about sensor wear in the sensor 7.

The use of the system shall comply to SIL requirements. The contactless inductive data transmission however results in that the maximum bit error probability is assumed to be relatively bad. With respect to its bit error probability, the contactless inductive data transmission ranges between a wireless connection and an unshielded telephone cable.

In order for a particular safety class to be achieved, suitable data protection measures are required which enable the residual error probability R to be reduced to a transmission error rate A according to table 2. Calculations using the above formulas show that a Hamming distance of 10 needs to be verified. In relation to the above argumentation, it will then be impossible to protect more than 4 bytes by means of the CRC checksum. Of these 4 bytes, at least one byte of the header 1 is required as a “byte count” for the transmission of the user data length.

A transmission of the up to 255 bytes of the sensor 7 according to prior art would require a division into separate telegrams having a unique header 1 each. Along with the byte for the byte count, this header would have to comprise at least another byte for a telegram count enabling the separate telegrams to be reassembled afterwards, thus leaving a maximum of 2 bytes for the user data contained in a telegram. Consequently, the transmission of 255 bytes would then require a total of 128 telegrams, with a total of 1023 bytes to be transmitted. In the event that each telegram starts with a preamble comprising y preamble bytes, as it is often the case, the total amount of information to be transmitted would increase by 128*y bytes.

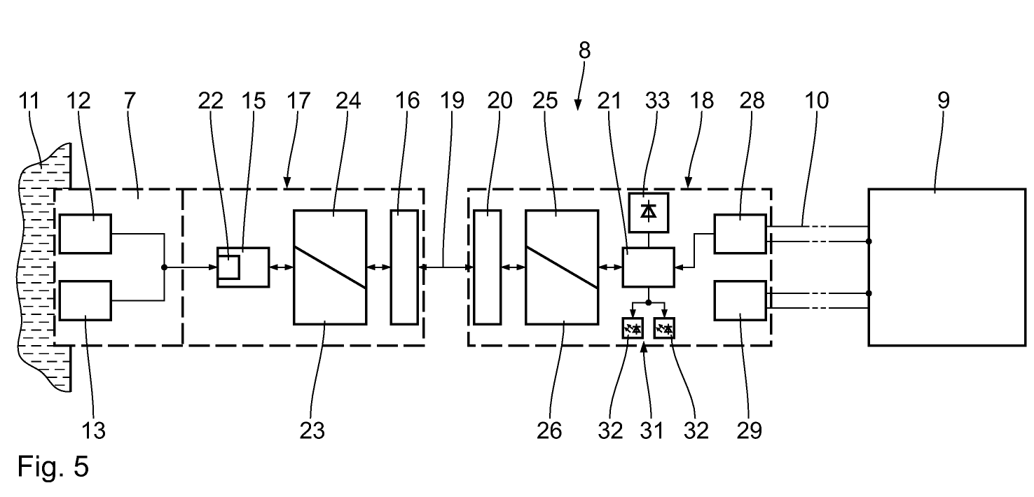

The inventive data protection method for the telegram comprising individually protected segments and a variable initial checksum value (see FIG. 4 plus description), enables a maximum of 255 bytes of user data to be transmitted in a single telegram comprising only 64 segments. Protected by a checksum of 32 bits, the first segment contains the header 1 with at least one byte for the telegram length as well as a maximum of 3 bytes of user data. The other segments contain user data of 4 bytes each and are protected in an equal manner. The last segment may be shorter, comprising user data of 1 byte and a checksum of 4 bytes. The transmission only requires a total of 512 bytes. In the event that a preamble of y bytes is used, the total amount of information to be transmitted only increases by these y preamble bytes.

A comparison between prior art and the inventive method shows that the inventive method is clearly advantageous when used in the example of pH measurement carried out under SIL conditions by means of the inductive contactless plug connection. As described above, the reliable transmission of sensor data of 255 bytes requires transmission of 1023 bytes according to prior art while only 512 bytes need to be transmitted when using the inventive method.

What is claimed is:

1. A method for data transmission in telegrams in a serial communication protocol comprising the following steps:
assigning user data to be transmitted to telegrams, a basic structure of which comprising
a telegram header (1) which includes information data concerning at least one of the group of a telegram length, addressing, distribution of the user data to be transmitted in several telegrams;
a user data block (2) which includes at least a part of the user data to be transmitted; and
a checksum block (3) which includes a checksum that is determined at least on the basis of the user data according to a checksum algorithm; and
transmitting the telegrams in consecutive intervals along a data transmission path (19), wherein
the user data block (2) of the telegrams is divided into several user data sub-blocks (2.1 to 2.k), each of which being protected separately by checksum sub-blocks (3.1 to 3.k).

2. A method according to claim 1, wherein a checksum determination takes place by means of the information data about the telegram length contained in the telegram header (1).

3. A method according to claim 1, wherein each user data sub-block (2.1 to 2.k) is followed by a checksum sub-block (3.1 to 3.k) which protects the former.

4. A method according to claim 1, wherein the checksum sub-blocks (3.1 to 3.k) for the individual user data sub-blocks (2.1 to 2.k) thereof are arranged separately at a defined position in the telegram.

5. A method according to claim 4, wherein the checksum sub-blocks (3.1 to 3.k) in the telegram are positioned upstream of the successive user data sub-blocks (2.1 to 2.k).

6. A method according to claim 4, wherein the checksum sub-blocks (3.1 to 3.k) in the telegram are positioned downstream of the successive user data sub-blocks (2.1 to 2.k).

7. A method according to claim 1, wherein each user data sub-block (2.1 to 2.k) is assigned a count value (6) that represents the position of the respective user data sub-block (2.1 to 2.k) in the telegram and is also protected by the respective checksum sub-block (3.1 to 3.k).

8. A method according to claim 1, wherein an initial value (6.1 to 6.k) is set for the determination of the checksum of a respective checksum sub-block (3.1 to 3.k) in dependence of the telegram position of the user data sub-block (2.1 to 2.k) protected thereby.

9. A data transmission device comprising
a data preparation device (15) on a side of a sender for arrangement of data to be transmitted in data telegrams;
a data transmission unit (16);
a data transmission path (19) disposed downstream thereof for transmission of the data telegrams emitted by the data sender unit (16);
a data receiver unit (20) disposed downstream thereof for receiving the data telegrams; and
a data evaluation device (21) for further processing of the data telegrams,
the data transmission device being adapted to execute following method steps for data transmission in telegrams in a serial communication protocol:
assigning user data to be transmitted to telegrams, a basic structure of which comprising
a telegram header (1) which includes information data concerning at least one of the group of a telegram length, addressing, distribution of the user data to be transmitted in several telegrams;
a user data block (2) which includes at least a part of the user data to be transmitted; and
a checksum block (3) which includes a checksum that is determined at least on the basis of the user data according to a checksum algorithm; and
transmitting the telegrams in consecutive intervals along a data transmission path (19), wherein
the user data block (2) of the telegrams is divided into several user data sub-blocks (2.1 to 2.k), each of which being protected separately by checksum sub-blocks (3.1 to 3.k).

10. A data transmission device according to claim 9, wherein the data transmission device is a contactless data transmission device in measuring systems.

11. A data transmission device according to claim 9, wherein the data sender unit (16), data transmission path (19) and data receiver unit (20) are designed as an inductive contactless plug connection.

12. A data transmission device according to claim 9, wherein the data transmission device is designed for data transmission in measuring systems between a measuring sensor (7) and a measuring device.

13. A data transmission device according to claim 12, wherein the measuring device is a measuring transducer (9).

14. A data transmission device according to claim 12, wherein the data preparation device (15) is assigned to a pH measuring sensor (7).
